(19) United States
(12) Patent Application Publication
(10) Pub. No.: US 2026/0163836 A1
(43) Pub. Date: Jun. 11, 2026

(54) ADAPTIVE PACKET SPRAY USING ON-DEMAND, NON-CASCADING, IN-BAND NETWORK TELEMETRY

(71) Applicant: Advanced Micro Devices, Inc., Santa Clara, CA (US)

(72) Inventor: Rajshekhar BIRADAR, Bangalore (IN)

(21) Appl. No.: 18/976,100

(22) Filed: Dec. 10, 2024

(51) Int. Cl. H04L 47/125; G06F 15/173; H04L 45/74; H04L 69/22

(52) U.S. Cl. CPC H04L 47/125; G06F 15/17331; H04L 45/74; H04L 69/22

(57) ABSTRACT

Adaptive packet spray using on-demand, non-cascading, in-band network telemetry permits an initiator node to obtain utilization metrics for paths of a packet-switched network, on-demand, by populating a header (e.g., an INT header) with a utilization metric, appending the header to multiple packets (e.g., RDMA packets), and transmitting the packets to a destination node via the respective paths. Each intermediate node of a path replaces the utilization metric of the header with the utilization metric of the intermediate node if the utilization metric of the intermediate node is greater than the utilization metric of the header. The highest utilization metric along the path serves as an occupancy/congestion metric for the path. The destination node receives the packets from the respective paths, prepares acknowledgments for the packets, and populates utilization metric fields of the acknowledgments with the utilization metrics of the respective packets.

### TECHNICAL FIELD

Examples of the present disclosure generally relate to adaptive packet spray using on-demand, non-cascading, in-band network telemetry.

### BACKGROUND

In packet-switched networking, load balancing refers to methods for balancing or allocating packets amongst paths to optimize resource usage and avoid dropped packets due to congestion. Load balancing methods include flow-based and packet-spray methods.

Flow-based methods allocate packet flows amongst network paths (i.e., packets within a given flow are assigned to the same path). Flow-based methods allocate at a packet-flow level rather than a more-granular packet-level. Flow-based methods do not account for differences in flow sizes. As a result, in some situations (e.g., high-bandwidth flows, such as artificial intelligence applications), it may not be possible to appropriately balance loads.

Packet-spray methods distribute packets equally amongst multiple paths (i.e., packets within a flow follow different paths). Packet spray methods do not account for differences in congestion or workloads of nodes along the paths, and thus may not make optimum use of available bandwidth.

### SUMMARY

Techniques for adaptive packet spray using on-demand, non-cascading, in-band network telemetry are described. One example is a system that includes a first network device that obtains utilization metrics from multiple paths between the first network device and a second network device of a packet-switched network, on-demand, including, populating a header with a utilization metric, appending the header to multiple packets containing payloads of an application program executing on the first network device, transmitting the packets having the appended header to the second network device via respective ones of the paths between the first and second network device, receiving acknowledgments of receipt of the packets from the second network device, wherein the acknowledgments comprise utilization metrics of respective one of the paths, and adjusting packet spray distribution weights associated with the paths based on the utilization metrics of the acknowledgments.

Another example described herein is a system that includes a first network device that receives a packet from an originating node of a packet-switched network, where the packet includes a payload of an application program executing on the originating node, determines that a header of the packet includes a utilization metric, replaces the utilization metric of the header with a utilization metric of the first network device if the utilization metric of the first network device is greater than the utilization metric of the header, and transmits the packet to a destination node of the packet-switched network.

Another example described herein is a system that includes a first network device that a first network device that receives multiple packets from an initiating node of a packet-switched network via multiple respective paths of the packet-switched network, parses utilization metrics from headers of the packets, populates acknowledgements of the packets with the utilization metrics of the headers of the respective packets, and transmits the acknowledgements to the initiating node.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts a network 100, according to an embodiment.

FIG. 2 depicts a method of initiating adaptive remote direct memory access (RDMA) packet spray using on-demand, non-cascading, in-band network telemetry, according to an embodiment.

FIG. 3 depicts a method of handling packets initiated by the method of FIG. 2, by intermediate nodes, according to an embodiment.

FIG. 4 depicts a method of handling the packets initiated by the method of FIG. 2, by a destination node, according to an embodiment.

FIG. 5 depicts a data processing unit, according to an embodiment

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe adaptive packet spray using on-demand, non-cascading, in-band network telemetry. Embodiments herein are described with respect to remote direct memory access (RDMA) packets. Embodiments herein are not, however, limited to RDMA packets.

RDMA over Converged Ethernet (RoCE) is a network protocol that allows RDMA over an Ethernet network. There are multiple RoCE versions. RoCE v2 enables direct memory access to a remote system through network interface controller (NIC) hardware by encapsulating an InfiniBand (IB) transport packet over Ethernet. RoCE v2 operates at the internet layer, allowing RoCE v2 packets to be routed. RoCE v2 offers low latency, high throughput, and minimal CPU involvement on both local and remote ends. In essence, RoCE v2 allows RDMA to run over generic IP networks, making it a powerful solution for network-intensive applications such as networked storage/cluster computing/AI workloads.

Early RDMA standards are directed to single path transport (i.e., RDMA packets only flow along one network path). Single path transport is prone to path failures and cannot utilize the rich parallel paths in modern datacenters. More recent RDMA standards that support multiple paths use a specific source port in a user datagram protocol (UDP) header. Actual paths may be determined based on an equal-cost multi-path (ECMP) routing strategy. An ECMP routing strategy essentially hashes different connections to different paths. ECMP routing strategies do not account for current path utilization. Thus, some paths a network may be highly congested, while other paths may have a low traffic load, reducing the overall network utilization.

Multi-path transport for RDMP (MP-RDMA) is a technique that uses a multi-path ACK-clocking mechanism to distribute traffic in a congestion-aware manner without incurring per-path states. MP-RDMA adjusts a congestion window based solely on explicit congestion notification (ECN) markings. MP-RDMA does not utilize real-time path occupancy metrics. Reaction time is thus slow, which may reduce its effectiveness in load balancing, and may lead to increased congestion.

Enhanced high precision congestion control (HPCC++) uses explicit in-band telemetry (INT) probe packets to obtain path utilization data. With INT probe packets, each intermediate node along a path adds a new INT header to the INT probe packet (i.e., cascaded INT headers), and a destination node parses the cascaded INT headers of the INT probe packet, and computes path utilization based on the parsed data. INT probe packets and parsing cascaded INT headers thus increase bandwidth overhead and latency.

Packet spray methods statically distribute traffic amongst available paths using different UDP source ports (i.e., without consideration of or adjusting for congestions/utilization differences amongst the paths).

Disclosed herein are on-demand, non-cascading methods of obtaining real-time path utilization metrics. In an example, an initiator node obtains utilization metrics, on-demand, by populating a header (e.g., an INT header) with a utilization metric, appending the header to multiple packets (e.g., packets related to an application program executing on the initiator node, such as ROCE v2 RDMA packets), and transmitting the packets to a destination node via respective paths of a network.

Each intermediate node of a path compares the utilization metric of the respective packet to a utilization metric of the intermediate node, and replaces the utilization metric of the packet with the utilization metric of the intermediate node if the utilization metric of the intermediate node is greater than the utilization metric of the packet. The highest utilization metric along a path serves as an occupancy metric for the path (e.g., path occupancy), between the initiating node and the destination node.

The destination node receives the packets from the respective paths, prepares acknowledgments (ACKs) for the packets, and populates utilization metric fields of the ACKs with the utilization metrics of the respective packets (i.e., without needing to compute path utilization metrics based on utilization metrics of intermediate nodes).

The originating node receives the ACKs, and determines whether to adjust a packet spray distribution weights based on the utilization metrics of the ACKs. In an example, the utilization metrics of three paths, A, B, and C, are 20%, 40%, and 70%, respectively. In this example, equal packet spray distribution weights is likely to result congestion on path C. As disclosed herein, the originating node may adjust the packet spray distribution weights based on the utilization metrics (e.g., such that 50% of packets are sent via path A, 35% of packets are sent via path B, and only 15% of packets are sent via path C). Dynamically adjusting the packet spray distribution weights based on the utilization metrics may ensure that the paths are utilized equally in real terms, and may reduce/avoid congestion.

The originating node may also adjust a frequency at which the originating node demands updated utilization metrics based on the utilization metrics.

The headers may piggyback on RDMA packets, and the utilization metrics may piggyback on corresponding RDMA ACKs.

Hence it is desirable to perform packet spray using real time queue/buffer occupancy details of all the network nodes in the path for optimal utilization of multipath bandwidth and to reduce possible drops/rate limiting due to congestion.

Methods disclosed herein may be useful for load balancing traffic for RDMA workloads and non-RDMA workloads.

Methods disclosed herein may be useful to rate-limit and balance traffic amongst paths between an initiator node and a destination node, without explicit congestion control mechanisms.

On-demand, non-cascading approaches disclosed herein may incur less bandwidth and latency overhead compared to other approaches (e.g., INT probe packets).

Methods disclosed herein may be useful in a variety of network applications, such as to improve throughput of artificial intelligence (AI) traffic and/or to reduction of congestion events in data centers.

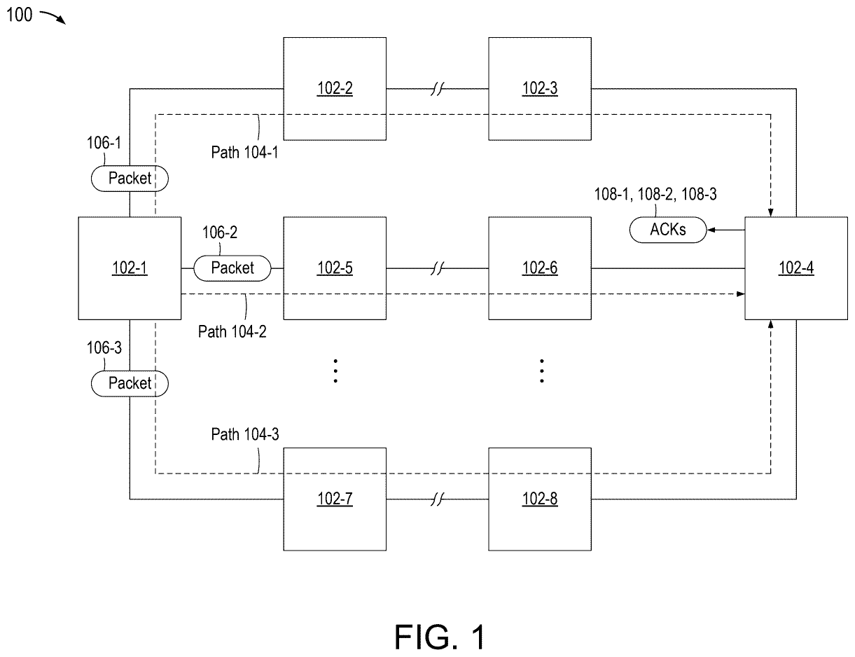

FIG. 1 depicts a network 100 of interconnected node 102-1 through 102-8 (collectively, nodes 102), according to an embodiment. Network 100 may represent a packet-switched network, and nodes 102 may represent network devices such as, for example and without limitations, routers, switches, hubs, bridges, modems, computers/servers, memory devices, and/or a printer. Nodes 102 may serve as connection points for data transmission, process recognition, packet switching, and network distribution. Nodes 102 may be programmed to identify, process, and transmit data from one node to another.

In an example, an application program is compiled to execute on nodes 102, or a subset thereof, and nodes 102 exchange packets containing payloads (i.e., data and/or instructions) related to the application program.

In an example, nodes 102 transmit packets to one another via multiple paths based on a packet spray distribution method. Examples are provided below in which node 102-1 transmits packets to node 102-4 via paths 104-2, 104-4, and 104-3 (collectively, paths 104). In the example of FIG. 1, path 104-1 includes nodes 102-2 and 102-3. Path 104-2 includes nodes 102-5 and 102-6. Path 104-3 includes nodes 102-7 and 102-8. In the following examples, node 102-1 may be referred to as an originating node, and node 102-4 may be referred to as a destination node.

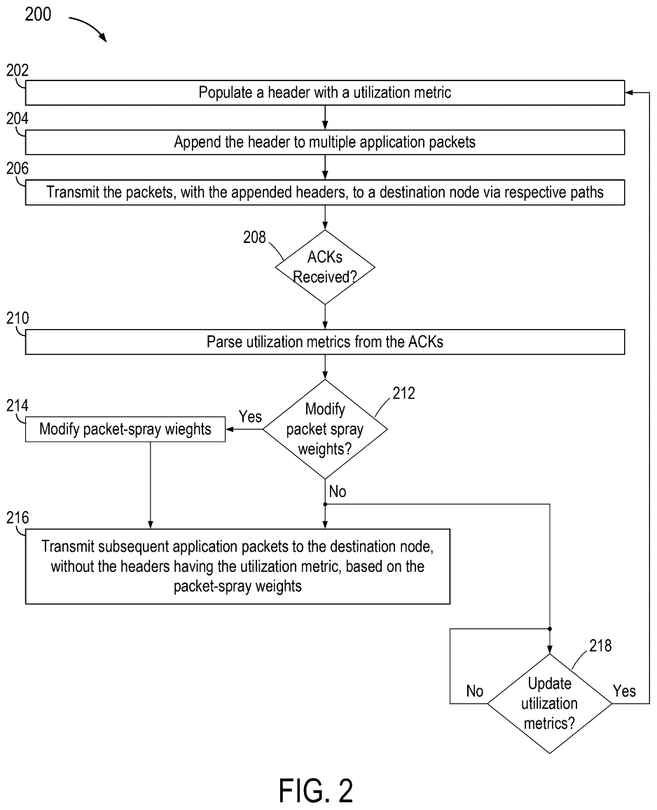

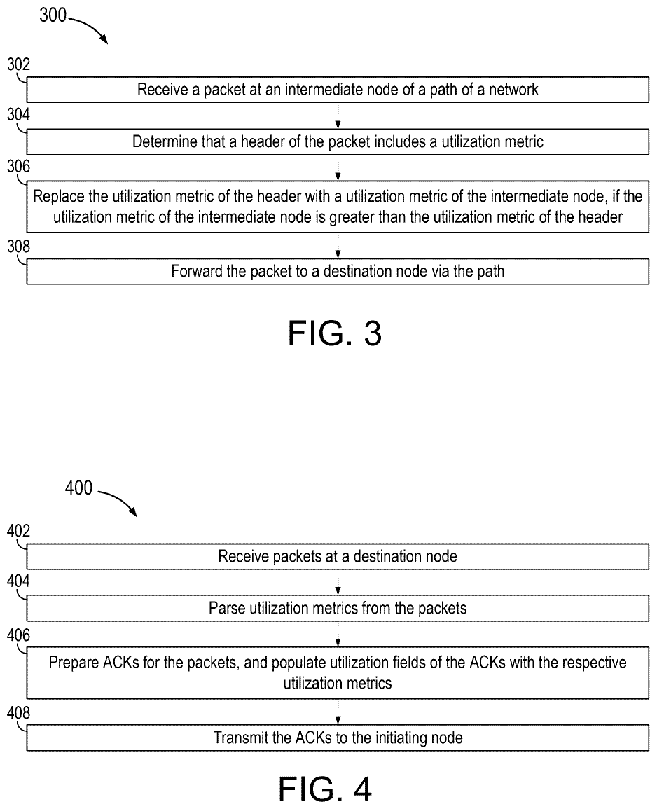

Network 100 is described below with reference to FIGS. 2, 3, and 4. FIG. 2 relates to an initiating node (e.g., node 102-1). FIG. 3 relates to intermediate nodes (i.e., nodes along paths 104). FIG. 4 relates to a destination node (e.g., node 102-4).

FIG. 2 depicts a method 200 of initiating adaptive remote direct memory access (RDMA) packet spray using on-demand, non-cascading, in-band network telemetry, according to an embodiment. Method 200 is described below with reference to network 100 of FIG. 1. Method 200 is not, however, limited to the example of FIG. 1.

At 202, initiating node 102-2 (e.g., a compute unit or a network interface controller of node 102-2) populates a header with an initial utilization metric (e.g., zero). Example utilization metrics are provided further below.

At 202, initiating node 102-2 appends the header to multiple packets. In the example of FIG. 1, initiating node 102-2 appends the header to three packets, 106-1, 106-2, and 106-3 (collectively, packets 106), one for each of paths 104-1, 104-2, and 104-3.

Initiating node 102-2 may append the header to packets related to an application program executing on node 102-2, such as remote direct memory access (RDMA) packets, rather than packets dedicated to management functions such as load balancing or congestion management functions. Packets related to an application program executing on node 102-2 (e.g., RDMA packets) may be referred to as application packets. Packets dedicated to management functions may be referred to as management packets. Appending the header to application packets rather than management packets may be useful to avoid increasing congestion. In an example, the header is an in-band telemetry (INT) header. In this example, node 102-2 may further append a user datagram protocol (UDP) header to the packets, preceding the INT header, to indicate that the subsequent header is an INT header.

At 206, initiator node 102-1 transmits packets 106 to destination node 102-4 via respective paths 104-1, 104-2, and 104-3 (e.g., based on a packet-spray method).

At 208, node 102-1 waits for acknowledgements (ACKs) of receipt of packets 106-1, 106-2, and 106-3 from destination node 102-4. While node 102-1 waits for acknowledgements (ACKs), intermediate nodes and destination node 102-4 may perform functions described below with reference to FIGS. 3 and 4.

FIG. 3 depicts a method 300 of handling packets 106 by the intermediate nodes, according to an embodiment. Method 300 is described below with reference to network 100 of FIG. 1. Method 300 is not, however, limited to the example of FIG. 1.

At 302, intermediate nodes 102-2, 102-5, and 102-7 receive respective packets 106-1, 106-2, and 106-4.

At 304, intermediate node 102-2 determines that a header of packet 106-1 includes the utilization metric. Intermediate node 102-2 may first determine that packet 106-1 includes an INT header, and may then determine that the INT header includes the utilization metric. Intermediate nodes 102-5 and 102-7 perform similar functions with respect to packets 106-2 and 106-3.

At 306, intermediate node 102-2 compares the utilization metric of the header to a utilization metric of intermediate node 102-2. Intermediate nodes 102-5 and 102-7 perform similar functions with respect to packets 106-2 and 106-3. The presence of the INT header may serve as an instruction to the intermediate nodes to compare the utilization metric of the header to a utilization metric of the respective intermediate nodes.

The utilization metric may relate to a work load (e.g., a queue/buffer occupancy) and/or resource usage (e.g., memory usage). The utilization metric may be readily available/accessible in hardware, such that the intermediate nodes can access/read the utilization metric(s) by calling a hardware-specific application programming interface (API), by reading a register(s), and/or other method. The utilization metric may readily available as metadata (e.g., INT metadata), such as egress link utilization, buffer/queue occupancy, and/or other metadata. The intermediate nodes may determine the utilization metrics as path occupancy ratios (PORs) based on a combination of metrics.

At 308, if the utilization metric of intermediate node 102-2 is greater than the utilization metric of the header of packet 106-1, intermediate node 102-2 replaces the utilization metric of the header with the utilization metric of intermediate node 102-2. If the utilization metric of intermediate node 102-2 is not greater than the utilization metric of the header, intermediate node 102-2 takes no action with respect to the header. Intermediate nodes 102-5 and 102-7 perform similar functions with respect to packets 106-2 and 106-3.

At 310, intermediate nodes 102-2, 102-5, and 102-7 forward respective packets 106-1, 106-2, and 106-2, with the appended headers, toward destination node 102-4 along respective paths 104-1, 104-2, and 104-3.

Method 300 may be repeated with respect to intermediate nodes 102-3, 102-6, and 102-8, when intermediate nodes 102-3, 102-6, and 102-8 receive respective packets 106-1, 106-2, and 106-3.

FIG. 4 depicts a method 400 of handling packets 106 by destination node 102-4, according to an embodiment. Method 400 is described below with reference to network 100 of FIG. 1. Method 400 is not, however, limited to the example of FIG. 1.

A 402, destination node 102-4 receives packets 106 via respective paths 104.

At 404, destination node 102-4 parses the utilization from the headers of packets 106-1, 106-2, and 106-3.

At 406, destination node 102-4 prepares acknowledgement (ACKs) 108-1, 108-2, and 108-3 (collectively, ACKs 108) for respective packets 106-1, 106-2, and 106-3, and populates utilization fields of ACKs 108 with the utilization of the respective packets.

At 408, destination node 102-4 transmits ACKs 108 to initiating node 102-1.

In the example of FIG. 3, an intermediate node updates the utilization metric of the header only if the utilization metric of the intermediate node is greater than the utilization metric of the header. Thus, when destination node 102-4 receives packets 106, each packet includes the worst-case utilization metric of a single node of the respective path. Although the worst-case utilization metric represents only a single node of a path, the worst-case utilization metric of the node may result in delay, congestion, and/or dropped packets, which impacts the entire path. Thus, in FIG. 4, destination node 102-4 need not receive utilization metrics of every intermediate node along a path (i.e., in respective headers), and need not compute path utilization metrics based on utilization metrics of every intermediate node along the path.

In FIG. 2, when initiating node 102-1 receives ACKs 108 at 208, processing proceeds to 210, where initiating node 102-1 parses the utilization metrics from ACKs 108.

At 212, initiating node 102-1 determines whether to adjust packet-spray distribution weights based on the utilization metrics parsed from ACKs 108. Initiating node 102-1 may determine to adjust the packet-spray distribution weights based a highest one of the utilization metrics, differences amongst the utilization metrics, comparison of one or more of the utilization metrics to a threshold(s), and/or based on another method(s).

If initiating node 102-1 determines to adjust the packet-spray distribution weights at 212, processing proceeds to 214, where initiating node 102-1 or other device, adjusts the packet-spray distribution weights. In an example, default or current packet-spray distribution weights may distribute/apportion packets sent from node 102-1 to node 102-4 equally amongst paths 104. If the utilization metric for path 104-1 is greater than the utilization metrics for paths 104-2 and 104-3, initiating node 102-1 may adjust the packet-spray distribution weights to reduce the proportion of packets sent via path 104-1. Initiating node 102-1 may, for example, adjust the packet-spray distribution weights such that 20% of the packets are sent via path 104-1, 40% of the packets are sent via path 104-2, and 40% of the packets are sent via path 104-3.

If the utilization metric for path 104-1 is significantly greater than the utilization metrics for paths 104-2 and 104-3, initiating node 102-1 may adjust the packet-spray distribution weights to reduce the proportion of packets sent via path 104-1 by a greater extent. Initiating node 102-1 may, for example, adjust the packet-spray distribution weights such that 10% of the packets are sent via path 104-1, 45% of the packets are sent via path 104-2, and 45% of the packets are sent via path 104-3. Method 400 is not limited to the foregoing examples.

At 216, initiating node 102-1 transmits subsequent application packets to destination node 102-4, without headers having the utilization metrics, based on the packet-spray distribution weights.

In an embodiment, at 218, initiating node 102-1 may determine to update the utilization metrics of paths 104 on-demand. Initiating node 102-1 may determine to update the utilization metrics based on a criterion, an event, and/or condition. In an example, initiating node 102-1 updates the utilization metrics periodically. Initiating node 102-1 may further determine an update frequency based on one or more of the utilization metrics and/or other factors. Examples are provided below.

Initiating node 102-1 may determine an update frequency that is approximately proportional to a highest one of the utilization metrics. In this example, when the highest utilization metric is relatively low, initiating node 102-1 updates the utilization metrics less frequently. When the highest utilization metric is relatively high, initiating node 102-1 updates utilization metric more frequently.

Initiating node 102-1 may determine an update frequency as one of multiple pre-determined frequencies based on corresponding thresholds (i.e., step-based increments). As an example, when the highest utilization metric is below a first threshold (e.g., 20% of a maximum value), initiating node 102-1 may set the update frequency to a first frequency (i.e., a relatively low frequency). When the highest utilization metric is above a second threshold (e.g., 60% of the maximum value), initiating node 102-1 may set the update frequency to a second frequency that is higher than the first frequency. Initiating node 102-1 is not limited to the foregoing example thresholds and frequencies. Initiating node 102-1 may utilize fewer than two thresholds/frequencies, or more than two thresholds/frequencies.

Setting the update frequency based on node-based utilization metrics may be appropriate since it may be assumed that, when a utilization metric is relatively low, it is less likely that the utilization metric will rise to a level of concern in the near term.

Initiating node 102-1 is not limited to proportional or step-based frequency updating. Initiating node 102-1 is also not limited to initiating utilization metrics based on utilization metrics. In another example, initiating node 102-1 may determine to update the utilization metrics based on an event (e.g., a host command, or an application event) and/or a condition.

When initiating node 102-1 determines to update the utilization metrics at 214, processing returns to 202.

In the foregoing examples, node 102-1 serves as an initiating node, node 102-4 serves as a destination node, and other nodes 102 serve as intermediate nodes. Each of nodes 102 may serve as an initiating node, an intermediate node, and a destination node. As an example, in addition to serving as an initiating node in the examples above, node 102-1 may also serve as a destination node for packets from one or more of nodes 102-2 through 102-8, and/or may serve as an intermediate node for packets sent between other pairs of nodes 102-2 through 102-8.

Further in the foregoing examples, initiating node 102-1 uses the utilization metrics to adjust packet-spray distribution weights. Alternatively, or additionally, the utilization metrics may be used for other purposes. As an example, a network manager may use the utilization metrics for network monitoring, security analysis, congestion alleviation (e.g., to dynamically assign or re-assign tasks/workloads amongst nodes 102), and/or for other purposes. If the network manager dynamically assign or re-assign tasks/workloads amongst nodes 102, the network manager may send a command to one or more nodes 102 to update the utilization metrics (i.e., to initiate/invoke method 400).

As described above, an initiating node determines utilization metrics on-demand, by appending regular application packets with a header containing a utilization metric (i.e., piggybacking on existing packets). An intermediate node updates the header only if the utilization metric of the intermediate node is greater than the utilization metric of the header (i.e., non-cascading, read and compare operations). The destination node merely pastes a single utilization metric from the header of each of the packets into respective ACKs (i.e., piggybacking on existing ACKs). The foregoing methods provide on-demand updating of utilization metrics and dynamic adjustment of packet spray distribution weights, with little, if any, added overhead or delay.

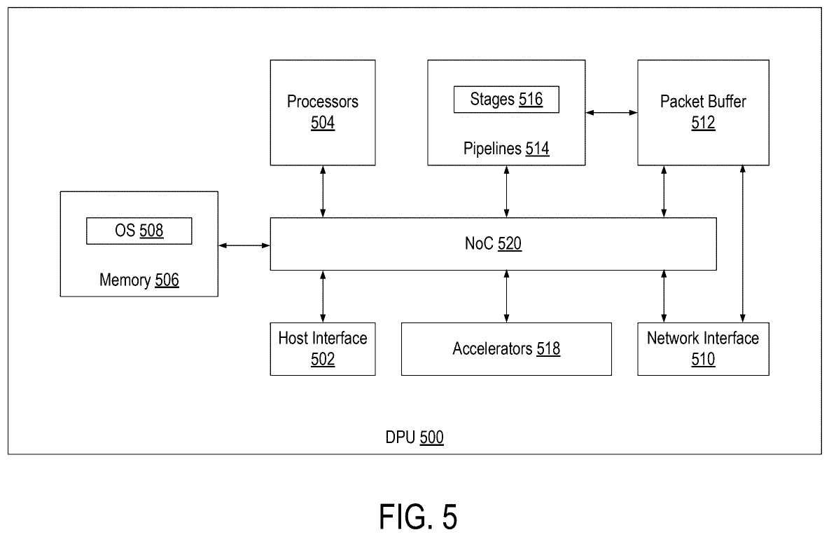

One or more of nodes 102 may include a data processing unit (DPU), such as described below with reference to FIG. 5. FIG. 5 depicts a DPU 500, according to an embodiment. In the example of FIG. 5, DPU 500 includes a host interface 502 that interfaces with a host. The host may include one or more central processing units (CPUs) and/or graphic processing units (GPUs), and may execute one or more application programs. Host interface 502 may include, for example and without limitation, a peripheral component interconnect express (PCIe) interface and/or other interface type(s).

DPU 500 further includes one or more processors 504, one or more of which may include multiple processing cores. Processors 504 may include CPUs, GPUs, and/or other type(s) of processors. Processors 504 may form one or more CPU core complexes. Processors 504 may include hardware/circuitry that uses an instruction set architecture (ISA) to process data, such as a complex instruction set computer (CISC) and/or reduced instruction set computer (RISC).

DPU 500 further includes memory 506, which may include volatile and/or non-volatile memory such as random access memory (RAM), high bandwidth memory (HBM), and/or other memory. Memory 506 may store an operating system (OS) 508 for execution by processors 504 (i.e., separate from a host OS).

DPU 500 further includes a network interface 510 that interfaces with one or more other network IO systems over a network, such as a packet-switched network. Network interface 510 may include an Ethernet interface and/or other interface type(s). DPU 500 may further include a packet buffer 512 that buffers incoming and/or outgoing packets.

DPU 500 may further include packet processing pipelines 514, which may include receive packet processing pipelines that process incoming packets from packet buffer 512, and/or transmit packet processing pipelines that process outgoing packets for transmission by network interface 510. Packet processing pipelines 514 may be programmable (e.g., based on the P4 programming language). Packet processing pipelines 514 may include multiple stages 516.

Packet processing pipelines 514 or a subset thereof (e.g., receive packet processing pipelines or transmit packet processing pipelines) may operate in parallel with one another. Packet processing pipelines 514 or a subset thereof (e.g., receive packet processing pipelines or transmit packet processing pipelines) may perform the same tasks or differing tasks. As an example, a subset of packet processing pipelines 514 may perform networking tasks, such as combining packets that were subdivided to be compatible with a maximum transmission unit (MTU). Another subset of packet processing pipelines 514 may perform tasks related to the host (e.g., interfacing with a host OS, drivers, and/or message descriptor formats in host memory). Alternatively, or additionally, another subset of packet processing pipelines 514 may serve as direct memory access (DMA) pipelines and/or remote direct memory access (RDMA) pipelines that handle DMA and/or RDMA access requests of the host.

Packet processing pipelines 514 may include multiple stages 516 (e.g., a set of data processing elements connected in series, where the output of one stage serves as the input to a subsequent stage). Stages 516 may perform respective processes on packets or portions thereof (. e.g., packet headers and/or packet payloads). In an example, DPU 500 further includes a parser that parses features of packets, such as packet header vector (PHV), for processing by stages 516 of one or more packet processing pipelines 514. Stages 516 may include circuitry, which may be configurable and/or programmable, such as with the P4 programming language. In an example, stages 516 of multiple packet processing pipelines 514 perform the same functions (e.g., in parallel). Alternatively, or additionally, stages 516 of multiple packet processing pipelines 514 perform differing functions.

Packet processing pipelines 514 and/or stages 516 may include local memory. The local memory may be programmed with local tables (e.g., match-action tables) that indicate whether/how packet processing pipelines 514 and/or stages 516 are to process a packet (e.g., based on features of the packet). In an example, one of stages 516 may perform a lookup operation to read a policy entry in a table to determine whether an entity associated with the packet has exceeded a rate limit (e.g., a packet rate limit and/or a data rate limit).

DPU 500 may further include one or more accelerators 518 that perform specialized tasks, such as data movement tasks. Accelerator(s) 518 may include, for example and without limitation, a cryptography accelerator, a data compression accelerator, an accelerator for performing regex or dedupe, and/or other accelerator type(s).

DPU 500 further include an interconnect, depicted here as a packet-based network-on-chip (NoC) 520 that provides communication links amongst other components of DPU 500. Alternatively, or additionally, the interconnect may include one or more other on-die or on-chip interconnects. In an example, the interconnect further includes direct or dedicated communication links (e.g., AXI interfaces) amongst two or more circuit blocks. In the example of FIG. 5, the interconnect further includes a communication link between packet buffer 512 and network interface 545. In another example, the interconnect includes a link between packet buffer 512 and packet processing pipelines 514. Processors 504 and packet processing pipelines 514 may communicate with one another via NoC 520.

DPU 500 may further include security and/or management features, which may provide a hardware root of trust, secure boot, and/or other features.

DPU 500 may be configurable as and/or integrated within a network interface controller/card (NIC), such as a SmartNIC, such as to process packets before they are forwarded to the host and/or to process packets for transmission.

DPU 500 may serve as a programmable processor system, which may be useful as an offload engine or accelerator. As an example, DPU 500 may perform functions of, or on behalf of an application program executing on the host, which may free the host to perform other functions of the application program and/or functions of other application programs. DPU 500 may efficiently handle data-centric workloads such as data transfer, reduction, security, compression, analytics, and/or encryption, at scale in data centers. DPU 500 may improve efficiency and performance of data centers by offloading workloads from the host, and may enhance computing power and/or handling of complex data workloads.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system, comprising:
a first network device configured to:
append a resource utilization metric to packets of an application program;
transmit the packets to a second network device via multiple respective paths of a packet-switched network based on a packet-spray method and path distribution weights;
receive acknowledgments of receipt of the packets from the second network device, wherein the acknowledgments comprise resource utilization metrics of the respective paths; and
adjust the path distribution weights based on the resource utilization metrics of the paths.

2. The system of claim 1, wherein the packets of the application program comprise remote direct memory access packets.

3. The system of claim 1, wherein the resource utilization metrics of the respective paths each comprise a resource metric of a most-congested network device of the respective path.

4. The system of claim 1, wherein the first network device is further configured to append the resource utilization metric within headers of the packets.

5. The system of claim 1, wherein the first network device is further configured to append the resource utilization metric within in-band telemetry headers of the packets.

6. The system of claim 1, wherein the first network device is further configured to append the resource utilization metric as metadata of the packets.

7. The system of claim 1, wherein the first network device is further configured to:
determine one or more of a time and a frequency at which to append the resource utilization metric to subsequent packets of the application program based on the resource utilization metrics of the respective paths.

8. The system of claim 1, wherein the resource utilization metric comprises one or more of a queue occupancy metric, a buffer occupancy metric, an egress link utilization metric, and a memory usage metric.

9. The system of claim 1, wherein the resource utilization metric comprises a path occupancy ratio that is based on multiple resource utilization metrics.

10. The system of claim 1, wherein the first network device is further configured to serve as an intermediate network device of a path between other network devices of the packet-switched network, including to:
receive a packet;
determine that the packet includes an appended resource utilization metric;
replace the appended resource utilization metric with a resource utilization metric of the first network device if the resource utilization metric of the first network device is greater than the appended resource utilization metric; and
transmit the packet to a destination node via the path.

11. The system of claim 1, wherein the first network device is further configured to serve as a destination network device, including to:
receive packets from an initiating network device via multiple respective paths between the initiating network device and the first network device;
parse resource utilization metrics appended to the packets received from the initiating network device;
populate acknowledgements of the packets received from the initiating network device with the parsed resource utilization metrics; and
transmit the acknowledgements of the packets received from the initiating network device to the initiating network device.

12. A system, comprising:
a first network device configured to:
receive a packet of an application program via a packet-switched network;
determine that the packet includes an appended resource utilization metric;
replace the appended resource utilization metric with a resource utilization metric of the first network device if the resource utilization metric of the first network device is greater than the appended resource utilization metric; and
transmit the packet to a destination network device via the packet-switched network.

13. The system of claim 12, wherein the packet comprises a remote direct memory access packet.

14. The system of claim 12, wherein the resource utilization metric comprises one or more of a queue occupancy metric, a buffer occupancy metric, an egress link utilization metric, and a memory use metric.

15. The system of claim 12, wherein the first network device is further configured to:
retrieve the resource utilization metric of the first network device from one or more of a register and a buffer.

16. The system of claim 12, wherein the first network device comprises:
an application programming interface configured to retrieve the resource utilization metric of the first network device from a hardware-based source of the first network device.

17. The system of claim 12, wherein the appended resource utilization metric is appended to the packet as one or more of metadata and a header of the packet.

18. A system, comprising:
a first network device configured to:
receive multiple packets of an application program from an initiating network device via multiple respective paths of a packet-switched network;
parse resource utilization metrics that are appended to the packets;
populate acknowledgements of receipt the packets with the parsed resource utilization metrics of the respective packets; and
transmit the acknowledgements to the initiating network device.

19. The system of claim 18, wherein the parsed resource utilization metrics comprise one or more of a queue occupancy metric, a buffer occupancy metric, an egress link utilization metric, and a memory use metric.

20. The system of claim 18, wherein the resource utilization metrics comprise a resource metrics of a most-congested network device of the respective paths.
